(19) United States
(12) Patent Application Publication
(10) Pub. No.: US 2013/0103258 A1
(43) Pub. Date: Apr. 25, 2013

(54) CREATION OF COST FUNCTION

(71) Applicants: Martin Evaldsson, Nacka (SE); Maria Södergren, Segeltorp (SE); Oskar Johansson, Stockholm (SE)

(72) Inventors: Martin Evaldsson, Nacka (SE); Maria Södergren, Segeltorp (SE); Oskar Johansson, Stockholm (SE)

(21) Appl. No.: 13/808,026

(22) PCT Filed: Jul. 14, 2011
(86) PCT No.: PCT/SE2011/050950

§ 371 Date: Jan. 2, 2013

(30) Foreign Application Priority Data
Jul. 16, 2010 (SE) 1050809-1

(51) Int. Cl. G06F 17/00

(52) U.S. Cl. CPC G06F 17/00
USPC 701/36; 701/93; 701/51; 701/1

(57) ABSTRACT

Disclosed is a cost function that depends on at least a first term and a second term which have a mutual relationship between them. The cost function is also so configured that it is easy to expand to cover one or more further terms. The cost function is created such that when it is expanded to depend on the first term, the second term and at least one further term the cost function still maintains the same mutual relationship between the first term and the second term. The cost function also indicates a mutual relationship between the at least one further term and the first and second terms.

### TECHNICAL FIELD

The present invention relates to a method for creating a cost function according to the preamble of claim 1, to a control unit according to the preamble of claim 18 and to a motor vehicle according to the preamble of claim 19. The present invention relates also to a computer program and a computer program product.

### BACKGROUND

In motor vehicles, e.g. passenger cars, trucks, buses or the like, cost functions are often employed in various optimisation algorithms in order to determine various parameters which are used for controlling the vehicle's functions. Such optimisation algorithms are used for example in control of cruise controls, control of gear choices and control of gear changing in automatic gear change systems, and in regulation of engine response, in regulation of an engine fan or in regulation of combustion emissions. In this specification the invention is exemplified for use in a cruise control system, e.g. a look-ahead cruise control (LACC), i.e. an intelligent cruise control which makes use of knowledge about the nature of the road ahead. However, the invention concerns general creation of a cost function and is therefore not restricted to implementation, as herein exemplified, in a cruise control. The invention may therefore be used at least where optimisation algorithms are used as above.

An object of cruise control is to achieve a uniform predetermined vehicle speed and to limit the highest speed which the motor vehicle can have. If the vehicle exceeds the highest speed allowed by it, the cruise control is allowed to brake the vehicle. An overriding object of the cruise control is to keep fuel consumption down as much as possible, since this is a factor which very greatly affects profitability for vehicle owners, e.g. haulage companies or the like.

An experienced driver driving a vehicle without cruise control may reduce fuel consumption by adapting his/her driving to the characteristics of the road ahead, so that unnecessary braking and/or fuel-consuming acceleration can be avoided. Current LACCs try to mimic the experienced driver's adaptation of the driving of the vehicle on the basis of knowledge about the road ahead so that fuel consumption can be kept at as low a level as possible.

To achieve lowest possible fuel consumption, current LACCs therefore try to adopt an optimum vehicle peed profile based on their knowledge of the road ahead. This knowledge may for example be based on information related to topology and road curvature, to a prevailing traffic situation or to the state of a section of road ahead. Such information is available inter alia from maps, positioning systems, e.g. GPS (global positioning system), and weather reports.

On the basis of such information a cruise control can calculate an optimum speed profile for the vehicle to follow. These optimisation calculations often employ cost functions, in which case the optimisation is based on minimising one or more such cost functions. In other words, the cruise control's optimisation problem may be expressed as

min f(x) (eq. 1)

in which

f(x) is the cost function, and

x ∈ X, where X represents all permissible states for the variable x.

The cost function may also be multidimensional, i.e. it may depend on more than one variable/aspect, examples of such aspects being journey time and the weight of fuel consumed. In previously known cruise control systems, the journey time aspect has been weighed against the fuel consumed aspect. The cost function has then been defined such that these aspects are weighed against one another in a linear way by means of weighting coefficients:

f=a₁T+a₂M (eq. 2)

in which

f is the cost function,

T is the journey time,

M is the weight of fuel consumed, and

a₁ and a₂ are weighting coefficients.

Of these:

$$T = {\int }_{0}^{{S}_{tot}} \frac{1}{υ} d s \\ and \\ M = {\int }_{0}^{{S}_{tot}} {m}_{f} d s \qquad ( eq . 3 )$$

in which

v is the vehicle speed,

m_{f} is fuel consumed per unit distance travelled, and

Sₜₒₜ is the length of the section of road covered by optimisation.

The magnitude of the weighting coefficients relative to one another steers the solution to the optimisation problem in equation 1 either towards shorter journey time with high fuel consumption or towards longer journey time with low fuel consumption. In arriving at this solution and hence the cruise control desired, the choice of the weighting coefficients is very important. Their magnitude is also very important in that it affects the computational complexity when equation 1 is evaluated.

Determining these weighting coefficients for the previously known cruise control systems so that the desired solution to the optimisation problem is achieved, while at the same time keeping the complexity of the numerical calculations at an acceptable level, has previously led to significant evaluation work.

Moreover, the linear cost function according to equation 2 is very difficult to add further aspects to, since all the weighting coefficients have then to be calculated again.

The linear cost function also results in the optimisation procedure, i.e. the search for minima according to equation 1, becoming ineffective. This is described in more detail below.

### BRIEF DESCRIPTION OF THE INVENTION

An object of the present invention is to propose a solution to the above problem.

The present invention relates to the aforesaid method for creating a cost function according to the characterising part of claim 1, to the aforesaid control unit according to the characterising part of claim 18 and to the aforesaid motor vehicle according to the characterising part of claim 19. The present invention relates also to the aforesaid computer program and the aforesaid computer program product.

The problems indicated above are solved by the present invention in that the cost function created according to it is very easy to expand to comprise substantially any desired number of terms. This is achieved by the cost function being so configured that upon the introduction of dependency on at least one further term it maintains a mutual relationship between the original at least first and second terms, and also indicates a mutual relationship between the at least one further term and the original at least first and second terms.

Each of these terms is based on an aspect which is relevant to the optimisation problem. Using the cost function according to the invention therefore allows the possibility of its adaptation to dependency on a suitable number of aspects. This makes it easy for the cost function to be adapted to different implementations which depend on different aspects and/or different numbers of aspects.

According to an embodiment of the present invention, aspect values which form part of the cost function are standardised. This standardisation of aspect values results in the scaling of the cost function becoming suited to numerical calculations, since the function value can be kept to a suitable magnitude.

The standardisation of the aspect values may be done with, for example, reference values obtained from a conventional cruise control, e.g. with a reference value for the journey time aspect and a reference value for the weight of fuel consumed aspect. Such standardisation means that the cost function according to the invention and its optimisation are placed in direct relation to corresponding cost function and optimisation for the conventional cruise control. A direct comparison is thus arrived at between the optimisation of the cost function according to the invention and the optimisation of the cost function of a conventional cruise control.

According to an embodiment of the invention, the respective at least first and second terms are each based on a standardised aspect value, which standardisation is effected by using a reference value for each aspect. If the respective aspect values each assume a value which is close to these reference values, the cost function arrives at a function value which is substantially one (1). Such a function value is obviously well suited to numerical calculations.

If the aspect value for the at least one further term keeps to values which that aspect normally assumes, i.e. values closely corresponding to those for the conventional cruise control, the cost function maintains substantially the function value which it had before the introduction of the at least one further dependency. In normal driving of the vehicle, the aspect value for the at least one further term will arrive at values close to those for the conventional cruise control. The function value can therefore be kept to a suitable magnitude even after the introduction of dependency on at least one further term.

According to an embodiment of the present invention, aspect values which form part of the cost function are squared. This squaring of the aspect values causes the slope of the cost function to be such that the solution is steered towards desirable points, thereby simplifying numerical calculations and also making the calculations effective.

The embodiments for the present invention are indicated in the dependent claims and are described in more detail below.

### BRIEF LIST OF DRAWINGS

The invention is explained in more detail below with reference to the attached drawings, in which similar reference notations are used for similar items, and in which

FIG. 1 is a graph of a standardised circular cost function,

FIG. 2 is a graph of a standardised circular cost function, and of a traditional linear cost function,

FIG. 3 is a graph of a standardised circular cost function, and of a traditional linear cost function, and

FIG. 4 depicts schematically a control unit.

### DESCRIPTION OF PREFERRED EMBODIMENTS

According to the present invention, the cost function is created such that it depends on at least a first term and a second term which have a mutual relationship between them. The cost function is also so configured that it can be expanded to cover one or more further terms. According to the invention, the cost function is created such that when it is expanded to depend on the first term, the second term and at least one further term it still maintains the same mutual relationship between the first term and the second term. The cost function also indicates a mutual relationship between the at least one further term and the first and second terms.

The cost function is also defined such that when the aspect value for the at least one further term is near in magnitude to its reference value, it has substantially the same function value when it depends only on the first term and the second term and when it depends on the first term, the second term and the at least one further term.

The fact that the mutual relationships between the first and second terms and between the first and second terms and the at least one further term, along with the fact that the function value is maintained at approximately the same value even when the cost function is expanded to depend on more terms, makes it easy to expand the cost function to depend on more terms. As described in more detail below, each of these terms is based on an aspect which is relevant to the optimisation problem. Being able to expand the cost function is very advantageous, since control of certain parameters, e.g. in a cruise control or in an automatic gear change system, does in fact depend on more than two aspects. Moreover, the dependencies may grow over time such that a parameter may depend during a period of time on two aspects but depend during another period of time on more than two aspects. To be able to optimise the control of the vehicle, e.g. so that minimum fuel consumption can be achieved for different vehicles, or for the same vehicle during different periods of time, the cost function needs to be adjusted so that it depends on more, or fewer, aspects. This is easy to accomplish with the present invention.

According to an embodiment of the present invention, the terms in the cost function, i.e. the respective first, second and at least one further term, are each based on an aspect which is related to said vehicle. The respective first and second terms are typically related, in the case of cruise control, to journey time and weight of fuel consumed. The at least one further term may, according to an embodiment of the present invention, be related to driving experience. This is described in more detail below. As a specialist in the field will appreciate, other aspects related to the vehicle may also be used for the cost function.

According to an embodiment of the present invention, the terms in the cost function, i.e. the respective first, second and the at least one further term, each take the form of a standardised aspect value. The aspect values are each standardised with an appropriate reference value for each aspect. For example, the value for the journey time aspect is standardised with a reference value for journey time, and a value for the weight of fuel consumed aspect is standardised with a reference value for weight of fuel consumed.

Standardising the aspect values in the cost function means that the scaling of the cost function is suited to numerical calculations, since the function value can be kept to a magnitude appropriate to this purpose. This makes it possible, if suitable reference values are chosen with which to standardise the aspect values, to control the scaling of the cost function, i.e. the magnitude of the cost function. Hence it is possible by means of the standardisation to choose the magnitude of the cost function such that it has, for normally occurring magnitudes of the aspect values, a value which is suited to numerical calculations and therefore reduces the computational complexity of the system. A suitable such value is one (1). In other words, standardising the cost function so that it has a function value near to one reduces the computational complexity. One skilled in the art will appreciate that different processors or other calculation devices may have different most advantageous function values about which to do their calculations, and also that the standardisation can be adapted so that such suitable function values are arrived at when such processors or other calculation devices are used for these calculations.

According to an embodiment of the present invention, corresponding values from a conventional cruise control are used as reference values. Thus what is used as a reference journey time is the journey time which would have been achieved by a conventional cruise control, and what is used as reference value for weight of fuel consumed is the weight of fuel consumed which would have been achieved by a conventional cruise control, and so on for other aspect values.

Using reference values from a conventional cruise control provides assurance of using reference values of suitable magnitudes, since it may be assumed that the aspect values for a cruise control which applies the present invention will be relatively near to those for a conventional cruise control. This means that the scaling of the cost function causes it to assume values which are near to one. This results, as described above, in computational advantages.

Standardisation with corresponding values for a conventional cruise control also affords a further advantage in that performance for a cruise control according to the invention can be related directly to a conventional cruise control. This is illustrated and described in more detail below.

According to an embodiment of the present invention, the terms in the cost function take the form of squared standardised aspect values. The aspect values will thus in this case have been first standardised with a suitable reference value, e.g. a corresponding value for a conventional cruise control, and will thereafter have been squared.

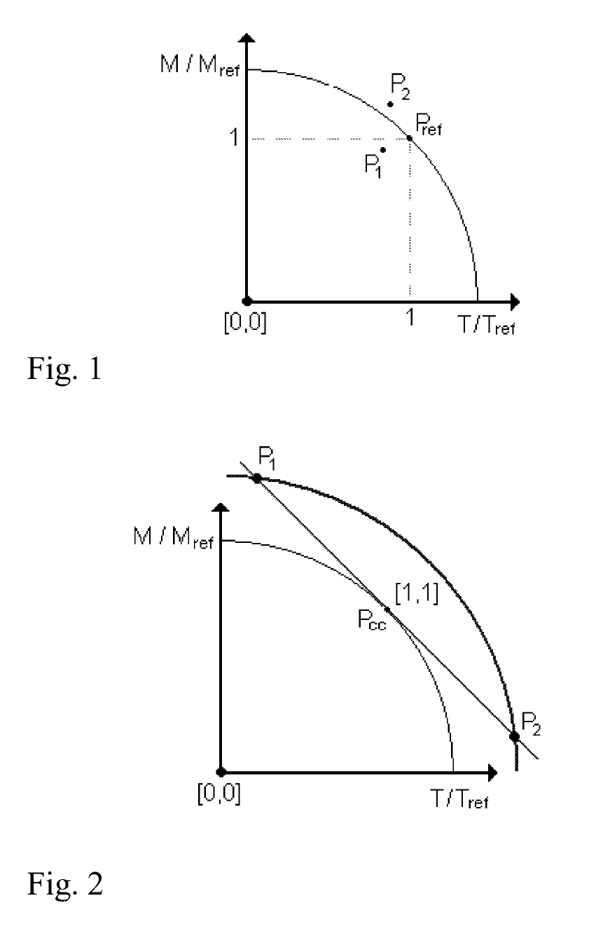

A cost function comprising two such squared standardised aspect values may be regarded as a circular representation of the cost function which differs from the traditional linear representation such as expressed for example in equation 2 above. According to the circular representation of the cost function, the cost is regarded as the radius of a circle with its center at the origin. This is illustrated in FIG. 1, in which the x axis denotes standardised and squared journey time and they axis standardised and squared weight of fuel consumed. The cost function depicted here is defined as

$$f = \frac{1}{\sqrt{2}} \sqrt{{( \frac{T}{{T}_{ref}} )}^{2} + {( \frac{M}{{M}_{ref}} )}^{2}} \qquad ( eq . 4 )$$

in which

T is the journey time,

T_{ref} is a reference journey time,

M is a weight of fuel consumed, and

M_{ref} is a reference value for a weight of fuel consumed.

In this circular representation of the cost function, the origin [0.0] is the optimum solution, but not a practically possible solution, since journey time and weight of fuel consumed would then both be zero. Other solutions in the

$$( \frac{T}{{T}_{ref}} , \frac{M}{{M}_{ref}} )$$

plane which are at the same distance from the origin are of equal value. In other words, solutions along a given arc are equally good solutions, whereas solutions which are further away from the origin than that arc are bad solutions. This is exemplified in FIG. 1, which shows that if for example reference values for a conventional cruise control are used for standardisation as described above, the arc on which the point P_{ref} is situated represents solutions which are just as good as the solutions for the conventional cruise control, since f(T_{ref}, M_{ref})=1 for these solutions. The point P1 which represents a solution for a cruise control according to the present invention is nearer to the origin than P_{ref}, resulting in a more optimised solution than that represented by P_{ref}. P₂ is further away from the origin than P_{ref}, which indicates that P₂ represents a worse solution than by the conventional cruise control.

As clearly indicated by the illustration in FIG. 1, the quadratic and standardised terms in the cost function result in a very easily comprehensible comparison between the cruise control according to the invention and a conventional cruise control, since all solutions which are better than the conventional cruise control result in function values which are within the arc formed by all the points with the function value one for the cost function.

It is also possible to rewrite equation 4 without using square roots, without losing the advantages of using squared aspect values. This is exemplified for other equations below.

FIG. 2 further illustrates the differences between a linear representation and a circular representation of the cost function. The traditionally used linear representation of the cost function is represented in FIG. 2 by the straight line between points P₁, P_{cc} and P₂, in which P_{cc} corresponds to P_{ref} in FIG. 1 above. According to this traditionally used representation, the respective solutions corresponding to P₁, P_{cc}, and P₂ are equally valid, since they are on the same linear line. Looking at FIG. 2 in more detail, however, shows clearly that the solutions at P₁ and P₂ are far away from the solution for a conventional cruise control, i.e. they are far away from the solutions on the arc with the function value one. The solutions at P₁ and P₂ are in practice not desirable in that their speed profiles are too far away from the speed profile for a conventional cruise control. In other words, the respective speed profiles corresponding to P ₁ and P₂ are far away from a set speed which is chosen by a driver to serve as an input signal for a cruise control.

In contrast, a circular representation shows clearly that the solutions at points P₁ and P₂ are not desirable, since they are situated outside the arc and are therefore further away from the origin than the solution points for a conventional cruise control. In other words, the circular representation shows that P₁ and P₂ are on a different arc from P_{cc}which is nearer to the origin. Thus the respective standardised squared cost functions for the points P₁ and P₂ assume a higher value than value for the standardised squared cost function for the point P_{cc}.

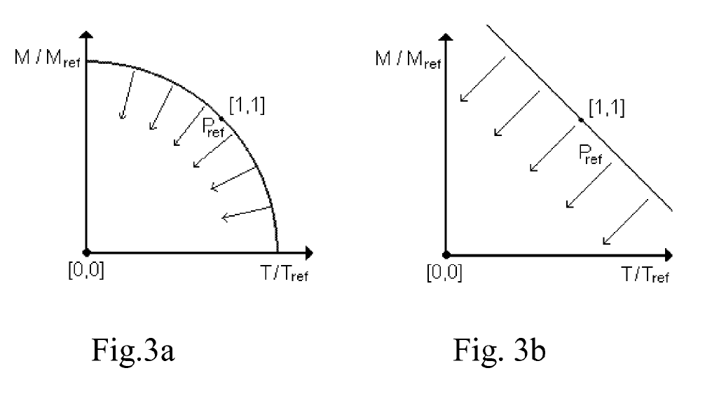

FIGS. 3a-b illustrate schematically the differences between the slopes of the traditionally used linear representation for the cost function and of the circularly represented cost function according to the invention. The slopes of the linearly represented cost function run downwards to the left, as per the arrows in FIG. 3b. In the case of the circularly represented cost function according to the present invention, depicted in FIG. 3a, all the slopes run instead directly towards the origin, resulting in solutions situated at desirable points, with comparable gains on time and on fuel. The direction of the slopes steers the solution towards a diagonal which runs through the origin at an angle of 45° to the horizontal axis. This is because points situated far away from the diagonal are regarded as less desirable when using the circularly represented cost function. Optimisation of the circular cost function therefore seeks a solution towards these desirable points along the diagonal, so the optimisation will be directed towards this diagonal. A solution close to this diagonal is desirable in that it is felt to be good and natural for a driver of the vehicle, since solutions close to the diagonal result in speed profiles resembling those of conventional cruise controls.

In the case of the traditionally used linear representation, only certain slopes run towards the desirable points along the diagonal, as illustrated in FIG. 3b, whereas the great majority run towards non-optimum points aside from the diagonal. A quicker solution to the optimisation problem is thus arrived at by using a cost function according to the present invention than by using a linearly represented cost function, since points which are far from the diagonal are valued worse with the circularly represented cost function than with the linearly represented cost function. This is also illustrated in FIG. 2, in which the points P₁ and P₂ are as desirable as the diagonal point P_{cc} according to the linearly represented cost function, whereas they are less desirable than P_{cc} according to the circularly represented cost function according to the invention.

By means of weighting coefficients it is possible for the relationship between the constituent terms of the cost function to be indicated such that the various terms are given different weights in the cost function, i.e. they are valued differently. The cost function may then be regarded as an elliptical representation, since the various weighting coefficients are given mutually different values, resulting in different extents along the x axis and they axis in the

$$( \frac{T}{{T}_{ref}} , \frac{M}{{M}_{ref}} )$$

plane.

According to an embodiment of the present invention, the mutual relationship between the terms in the cost function takes the form of convex combinations. The weighting coefficients in the cost function therefore take the form here of convex combinations. When convex combinations are used for the weighting coefficients, the resulting values are between zero and one, and the aggregate of the weighting coefficients remains one. An example of such a cost function is

$$f = \sqrt{{β ( \frac{T}{{T}_{ref}} )}^{2} + ( 1 - β ) {( \frac{M}{{M}_{ref}} )}^{2}} \qquad ( eq . 5 )$$

in which

T is the journey time,

T_{ref} is a reference journey time,

M is a weight of fuel consumed,

M_{ref} is a reference value for a weight of fuel consumed, and

β is a weighting coefficient, where β ∈[0.1].

As indicated above, the cost function according to equation 5 may also be written in a form in which the square root is not used, such as

$$f = {β ( \frac{T}{{T}_{ref}} )}^{2} + ( 1 - β ) {( \frac{M}{{M}_{ref}} )}^{2} \qquad ( eq . 6 )$$

in which

T is the journey time,

T_{ref} is a reference journey time,

M is a weight of fuel consumed,

M_{ref} is a reference value for a weight of fuel consumed, and

β is a weighting coefficient, where β ∈[0.1].

Using convex combinations as weighting coefficients provides assurance that the cost function will have a function value close to one if standardisation is applied and if the aspect values assume values relatively near to their respective reference values as above. This magnitude of the function value facilitates numerical calculations which involve the cost function and therefore generates less computational complexity. Using convex combinations as weighting coefficients to indicate the relationship between the terms in the cost function therefore means that the function value of the cost function is not affected by mutual relations between the coefficients, since their aggregate value amounts to one.

According to traditionally used cost functions such as that indicated in equation 2, the weighting coefficients a₁ and a₂ may assume any desired values, often leading to function values considerably greater than one and hence also to increased computational complexity.

Equations 5 and 6 use not only the convex combinations for the relationship between the terms but also standardisation of the aspect values. As described above, this standardisation also means that the function value for the cost function is kept around one in the case of normally occurring aspect values. The combination of the standardisation and the use of the convex combinations results according to the present invention in the cost function arriving at a function value which is very well suited to further numerical calculations.

It is also possible, according to an embodiment of the invention, for the cost function to be expanded to depend on at least one further aspect in addition to those of journey time and weight of fuel consumed. An example of such a further aspect is driving experience. The fact that the cost function according to the invention is created such that new terms can be added to it without altering the relationship between the terms already incorporated in it makes it easy to add further terms. If the cost function is thus caused to depend on three terms, the result is a spherical representation of the cost function. In a similar way to the two original terms, the various terms may be weighted relative to one another.

In other words, the cost function is so configured that the mutual relationship between the at least two original constituent terms of the cost function, in this example those related to journey time and weight of fuel consumed, is maintained when further terms are added to it. At the same time, the at least one further term is given a relationship to the at least two original terms.

According to an embodiment of the present invention, the mutual relationship between the at least two original constituent terms, and that between the at least one further term and the at least two original terms, take the form of convex combinations. The terms also take the form of standardised and squared aspect values. This makes adding new terms to the cost function possible and easy, since the function value for the cost function at the time of their addition substantially maintains its function value for aspect values near to the respective reference value, i.e. the cost function substantially maintains a value near to one.

A cost function which depends on journey time, weight of fuel consumed and driving experience may, according to an embodiment of the present invention, be defined as

$$f = {γβ ( \frac{T}{{T}_{ref}} )}^{2} + γ ( 1 - β ) {( \frac{M}{{M}_{ref}} )}^{2} + ( 1 - γ ) {( \frac{κ}{{κ}_{ref}} )}^{2} \qquad ( eq . 7 )$$

in which

T is the journey time,

T_{ref} is a reference journey time,

M is a weight of fuel consumed,

M_{ref} is a reference value for a weight of fuel consumed,

κ is a value for driving experience,

κ_{ref} is a reference value for driving experience,

β is a weighting coefficient, where β ∈[0.1], and

γ y is a weighting coefficient, where γ ∈[0.1].

As indicated above, equation 7 may also be written in a form in which the square root of the expression is used.

One skilled in the art will appreciate that the driving experience aspect may be defined and determined in various different ways. One way of determining a value for the driving experience aspect is, according to an embodiment of the invention, to define it as depending on two terms respectively based on acceleration change for the vehicle and speed experience for the driver.

Acceleration change (“jerking”) may be used as a measure of experience of driving, since it is likely to be felt to have adverse effects upon driving comfort. Thus jerking may be defined as

j=\dot{a} (eq. 8)

in which

\dot{a} is the acceleration change.

A measure of the extent to which jerking affects comfort may also be presented as

$$J = {\sum }_{k = 0}^{N} \vert {j}_{k} \vert \qquad ( eq . 9 )$$

in which jerking at N points is summated. The absolute amount means that jerking in both positive and negative directions is summated, resulting in all types of jerking being regarded as affecting comfort.

The speed experience may be determined as

$$Y = {\sum }_{k = 0}^{N} max ( \frac{{v}_{ref} - {v}_{k}}{{v}_{k}} \cdot 0 ) \qquad ( eq . 10 )$$

in which

v_{ref} is a reference speed, and

vₖ is an instantaneous speed of the vehicle.

It is here assumed that the speed experience is adversely affected at below the reference speed, which may for example be a permissible speed on a section of road.

If irritation about being above the reference speed is also to be taken into account, the following expression may be used instead for the speed experience:

$$R = {\sum }_{k = 0}^{N} \vert \frac{{v}_{ref} - {v}_{k}}{{v}_{k}} \vert \qquad ( eq . 11 )$$

in which

v_{ref} is a reference speed, and

vₖ is an instantaneous speed of the vehicle.

With a definition of driving experience as above, the following expression for the speed experience may be presented:

$${( \frac{κ}{{κ}_{ref}} )}^{2} = {ψ ( \frac{J}{{J}_{ref}} )}^{2} + ( 1 + ψ ) {( \frac{Y}{{Y}_{ref}} )}^{2} \qquad ( eq . 12 )$$

in which

κ is a value for driving experience,

κ_{ref} is a reference value for driving experience,

J is a value for acceleration change,

J_{ref} is a reference value for acceleration change,

Y is a value for speed experience,

Y_{ref} is a reference value for speed experience, and

ψ is a weighting coefficient, where ψ ∈[0.1].

Equation 7 and equation 12 may also be written together as a total expression for the cost function when it depends on journey time, weight of fuel consumed and driving experience. Such an expression may be written as

$$f = {γβ ( \frac{T}{{T}_{ref}} )}^{2} + γ ( 1 - β ) {( \frac{M}{{M}_{ref}} )}^{2} + ( 1 - γ ) {ψ ( \frac{J}{{J}_{ref}} )}^{2} + ( 1 - γ ) ( 1 - ψ ) {( \frac{Y}{{Y}_{ref}} )}^{2} \qquad ( eq . 13 )$$

in which γ, β, Ψ ∈[0.1] and elements in a vector comprising the weighting coefficients, i.e. elements in the vector

$$\overline{v} = [ \begin{matrix}γβ \\ γ ( 1 - β ) \\ ( 1 - γ ) ψ \\ ( 1 - γ ) ( 1 - ψ )\end{matrix} ]$$

are added to the value one, since they take the form of convex combinations. As a result of the standardisation, the squaring and the use of the convex combinations as weighting coefficients, this expanded cost function according to the present invention still has a function value which is substantially unchanged after the expansion if the further aspect value is relatively near to its reference value. The function value will thus likewise be substantially one for the expanded function if all the aspect values in the cost function are relatively near to their respective reference values.

The present invention is exemplified above for an implementation in a cruise control but, as a specialist in the field will appreciate, the cost function according to the invention may be employed in many contexts in a motor vehicle. The cost function according to the present invention may be used for substantially all types of regulation which involve a number of different aspects being weighed together in a cost function. Such aspects may possibly even be mutually contradictory. Some non-limitative examples of use of the cost function are in optimisation of a parameter which is related to controlling an intelligent cruise control, an automatic gearbox, regulation of engine response, regulation of an engine fan, regulation of combustion emissions.

As one skilled in the art will appreciate, these various optimisations and regulations require different input signals and are based on different aspects. Specialists will therefore appreciate that the aspects exemplified above such as journey time, weight of fuel consumed and driving experience might in implementations other than for cruise control be replaced in the terms of the cost function by other suitable aspects. In other words, the cost function according to the present invention is not restricted to implementation in cruise controls, nor to depending on the aspects exemplified above.

As indicated above, all of the expressions for the cost functions may be expressed with or without use of a notation comprising a square root.

Specialists will appreciate that a method for creating a cost function according to the present invention may also be implemented in a computer program which, when executed in a computer, causes the computer to apply the method. The computer program is contained in a computer program product's computer-readable medium which takes the form of a suitable memory, e.g. ROM (read-only memory), PROM (programmable read-only memory), EPROM (erasable PROM), flash memory, EEPROM (electrically erasable PROM), a hard disc unit, etc.

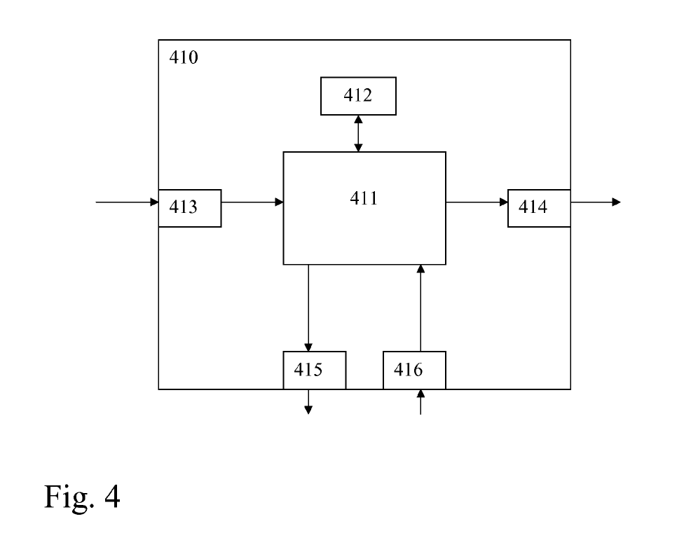

FIG. 4 depicts schematically a control unit 410. The control unit 410 comprises a calculation unit 411 which may take the form of substantially any suitable type of processor or microcomputer, e.g. a circuit for digital signal processing (digital signal processor, DSP), or a circuit with a predetermined specific function (application specific integrated circuit, ASIC). The calculation unit 411 is connected to a memory unit 412 which is incorporated in the control unit 410 and which provides the calculation unit 411 with, for example, the stored program code and/or the stored data which the calculation unit 411 needs for it to be able to perform calculations. The calculation unit 411 is also adapted to storing partial or final results of calculations in the memory unit 412.

The control unit 410 is further provided with respective devices 413, 414, 415, 416 for receiving input signals and sending output signals. These input and output signals may comprise waveforms, pulses or other attributes which the signal receiving devices 413, 416 can detect as information and which can be converted to signals which are processable by the calculation unit 411. The calculation unit 411 is then provided with these signals. The signal sending devices 414, 415 are adapted to converting signals received from the calculation unit 411 in order, e.g. by modulating them, to create output signals which can be conveyed to other parts of the system. The input signals to the system are provided in conventional ways, e.g. by means of sensors, by use of models or in some other similar way known to specialists.

Each of the connections to the respective devices for receiving input signals and sending output signals may take the form of one or more from among a cable, a data bus, e.g. CAN (controller area network) bus, an MOST (media orientated systems transport) bus or some other bus configuration, or a wireless connection. One skilled in the art will appreciate that the aforesaid computer may take the form of the calculation unit 411 and that the aforesaid memory may take the form of the memory unit 412.

The control unit according to the invention is adapted to creating a cost function for use in a motor vehicle, which cost function depends on at least a first and a second term, indicates a mutual relationship between these at least first and second terms and assumes a function value. The control unit is further adapted to configuring the cost function such that dependency on at least one further term can easily be introduced into the cost function. Upon such introduction, the cost function maintains the mutual relationship between the at least first and second terms and also indicates a mutual relationship between the at least one further term and these at least first and second terms.

According to an embodiment of the control unit, the cost function maintains substantially the same function value even after the introduction of one or more further terms if the aspect value for this at least one further term is relatively near to the reference value with which it is standardised.

Specialists will also appreciate that the above control unit may be adapted to effecting the various embodiments of the method according to the invention. The invention relates also to a motor vehicle, e.g. a truck or a bus, comprising at least one such control unit for creating a cost function according to the invention.

The present invention is not restricted to the embodiments described above of the invention but relates to and comprises all embodiments which fall within the protective scope of the attached independent claims.

1. A method for creating a cost function for use in a motor vehicle, which cost function depends on at least a first and a second term, indicates a mutual relationship between said at least first and second terms, and assumes a function value, characterised in that said cost function is configured such that dependency on at least one further term can be introduced into said cost function, which will thereupon maintain said mutual relationship between said at least first and second terms and indicate a mutual relationship between said at least one further term and said at least first and second terms.

2. A method according to claim 1, whereby said at least first and second terms and said at least one further term are each based on a respective aspect related to said motor vehicle.

3. A method according to claim 2, whereby said at least first and second terms and said at least one further term each take the form of a respective standardised aspect value, which standardisation is effected by means of a reference value for each aspect.

4. A method according to claim 3, whereby said reference value takes the form of a corresponding value arrived at by means of a conventional cruise control.

5. A method according to any one of claims 2-4, whereby said at least first and second terms and said at least one further term each take the form of a respective squared standardised aspect value.

6. A method according to any one of claims 1-5, whereby said mutual relationships between said at least first and second terms take the form of convex combinations.

7. A method according to any one of claims 1-6, whereby said mutual relationships between said at least one further term and said first and second terms take the form of convex combinations.

8. A method according to any one of claims 7, whereby said cost function upon said introduction substantially maintains said function value if said at least one further term is based on a standardised aspect value, which standardisation is effected by means of a reference value for each aspect, and said aspect value assumes a value which is near to said reference value.

9. A method according to any one of claims 1-8, whereby said cost function depends on two terms based respectively on journey time and weight of fuel consumed.

10. A method according to claim 9, whereby said cost function is defined according to
$$f = {β ( \frac{T}{{T}_{ref}} )}^{2} + ( 1 - β ) {( \frac{M}{{M}_{ref}} )}^{2}$$
in which
T is the journey time,
T_{ref} is a reference journey time,
M is a weight of fuel consumed,
M_{ref} is a reference value for a weight of fuel consumed, and
β is a weighting coefficient, where β ∈[0.1].

11. A method according to any one of claims 1-8, whereby said cost function depends on three terms based respectively on journey time, weight of fuel consumed and driving experience.

12. A method according to claim 11, whereby said cost function is defined according to
$$f = {γβ ( \frac{T}{{T}_{ref}} )}^{2} + γ ( 1 - β ) {( \frac{M}{{M}_{ref}} )}^{2} + ( 1 - γ ) {( \frac{κ}{{κ}_{ref}} )}^{2}$$
in which
T is the journey time,
T_{ref} is a reference journey time,
M is a weight of fuel consumed,
M_{ref} is a reference value for a weight of fuel consumed,
κ is a value for said driving experience,
κ_{ref} is a reference value for said driving experience,
β is a weighting coefficient, where β ∈[0.1], and
γ is a weighting coefficient, where γ ∈[0.1].

13. A method according to claim 12, whereby the term for driving experience depends on two terms based respectively on acceleration change and speed experience.

14. A method according to claim 13, whereby the term for driving experience is defined according to
$${( \frac{κ}{{κ}_{ref}} )}^{2} = {ψ ( \frac{J}{{J}_{ref}} )}^{2} + ( 1 + ψ ) {( \frac{Y}{{Y}_{ref}} )}^{2}$$
in which
κ is a value for said driving experience,
κ_{ref} is a reference value for said driving experience,
J is a value for acceleration change,
J_{ref} is a reference value for acceleration change,
Y is a value for speed experience,
Y_{ref} is a reference value for speed experience, and
ψ is a weighting coefficient, where ψ ∈[0.1].

15. A method according to any one of claims 1-14, whereby said function value is substantially one if said at least first and second terms are each based on a respective standardised aspect value, which standardisation is effected by means of a reference value for each aspect, and the respective aspect values each assume a value which is near to said reference value.

16. A method for optimising a parameter in a motor vehicle, which optimisation is based on a cost function created according to any one of claims 1-15, said parameter being related to control of any of the following:
an intelligent cruise control,
an automatic gearbox,
regulation of an engine response.
regulation of an engine fan, and
regulation of combustion emissions.

17. A computer program which comprises program code and which when said code is executed in a computer causes said computer to apply the method according to any of claims 1-16.

18. A computer program product comprising a computer-readable medium and a computer program according to claim 17, which program is contained in said computer-readable medium.

19. A control unit adapted to creating a cost function for use in a motor vehicle, which cost function depends on at least a first and a second term, indicates a mutual relationship between said at least first and second terms, and assumes a function value, characterised in that said control unit is adapted to configuring said cost function such that dependency on at least one further term can be introduced into said cost function, which will thereupon maintain said mutual relationship between said at least first and second terms and indicate a mutual relationship between said at least one further term and said at least first and second terms.

20. A motor vehicle characterised in said vehicle comprises a control unit according to claim 19.
